(19) United States
(12) Patent Application Publication
(10) Pub. No.: US 2024/0116715 A1
(43) Pub. Date: Apr. 11, 2024

(54) AN APPARATUS FOR TRANSPORTING PRODUCTS ON A RESPECTIVE PATH, PARTICULARLY COMPRISING AT LEAST ONE CURVED LENGTH OR A CORRESPONDING SPIRAL ROUTE

(71) Applicant: BETT SISTEMI S.R.L., Carpi (MO) (IT)

(72) Inventor: Tienno BETTATI, Carpi (MO) (IT)

(21) Appl. No.: 17/769,212

(22) PCT Filed: Oct. 15, 2020
(86) PCT No.: PCT/IB2020/059687

§ 371 Date: Apr. 14, 2022

(30) Foreign Application Priority Data
Oct. 16, 2019 (IT) 102019000019040

(51) Int. Cl. B65G 17/08; B65G 17/34; B65G 21/18

(52) U.S. Cl. CPC B65G 17/086; B65G 17/345; B65G 21/18; B65G 2207/24

(57) ABSTRACT

An apparatus for transporting products on a respective path, particularly including at least one curved length or a corresponding spiral route, including respective support means of a conveyor belt, particularly including a plurality of mutually articulated meshes, in which preferably the respective mesh has a respective small transversally extending plate defining a resting surface for said product, and, on the perpendicular side opposite the same resting surface of the product, a portion for supporting said small plate and articulating the mesh to the adjacent meshes of the conveyor belt, which mesh supporting and articulating portion is slidable on a corresponding elongated block for supporting and guiding said means for supporting the apparatus. The conveyor belt, particularly the respective mesh thereof, includes volving friction sliding means that are adapted to engage said supporting and guiding elongated block at a corresponding perpendicular face thereof which faces the outer side of the bend.

### APPLICATION FIELD OF THE PRESENT FINDING

The present finding refers to an apparatus for transporting products on a respective path, particularly comprising at least one curved length or a corresponding spiral route.

### STATE OF THE ART

Apparatuses are known, for transporting products on a respective spiral path, preferably for carrying out a corresponding ascending or descending movement length of said products.

Said already-known spiral apparatuses generally comprise, respective means, or frame, for supporting a conveyor belt, for example of the type comprising a plurality of mutually articulated meshes for supporting the product, and which conveyor belt is slidable, with gliding, along respective guide means that are supported by said support means, or frame. However, these already-known conveying apparatuses, due to the fact that they develop an excessive friction between the belt and the supporting structure, require, in order to achieve the forwarding motion of the same belt, the use of an excessive towing power.

Other already-known spiral conveying apparatuses have, between the conveyor belt and the corresponding, guide means corresponding volving friction engaging means, defined by a plurality of small wheels converging on a respective guide cable. Therefore, these apparatuses have a very complex structure, which structure employs an overabundant number of components and which is difficult to manufacture and maintain.

Therefore, it would be desirable in the field to have an apparatus in which the advancement, or sliding, of the conveyor belt takes place in a particularly efficient manner.

It would also be desirable in the field to have available an apparatus, which has a particularly essential configuration.

Furthermore, it would also be desirable in the field to have an apparatus available, which promotes the engagement, or meshing, of said towing means with said conveyor belt, without causing excessive friction to the sliding of the conveyor belt.

### SUMMARY OF THE FINDING

By the present finding, it is aimed to propose a new and alternative solution to the solutions known so far, and particularly it is aimed to propose to obviate one or more of the drawbacks or problems referred to above and/or to satisfy one or more needs referred to above, and/or in any case felt in the art, and particularly evident from the above.

Therefore, an apparatus for transporting products on a respective path is provided, particularly comprising at least one curved length or a corresponding spiral route, the apparatus comprising respective support means of a conveyor belt, particularly comprising a plurality of mutually articulated meshes, in which preferably the respective mesh has a respective small transversally extending plate for supporting the product defining a resting surface for said product, and, extending from the perpendicular side opposite the same resting surface of the product, a portion for supporting said small plate for supporting the product and articulating the mesh to the adjacent meshes of the conveyor belt, which supporting and articulating portion of the mesh is slidable on a corresponding elongated block for supporting and guiding said support means of the apparatus; characterized in that said conveyor belt, particularly the respective mesh thereof, comprises volving friction sliding means that are adapted to engage said supporting and guiding elongated block at a corresponding perpendicular face or surface thereof which faces the outer side of the bend.

In this manner, a reduction of the friction along the path, particularly a curved path, particularly a spiral path, of the conveyor belt is obtained, thus considerably reducing the use of towing power, all with a configuration of the transporting apparatus that is particularly essential, i.e. using a relatively low number of components.

### BRIEF DESCRIPTION OF THE DRAWINGS

This and other innovative aspects are, however, set forth in the attached claims, the technical characteristics of which can be found, together with corresponding advantages achieved, in the following detailed description, illustrating a purely exemplary and non-limiting embodiment of the invention, and which is given with reference to the attached drawings, in which:

FIG. 1A illustrates a perspective schematic view of a preferred implementation of apparatus according to the present finding;

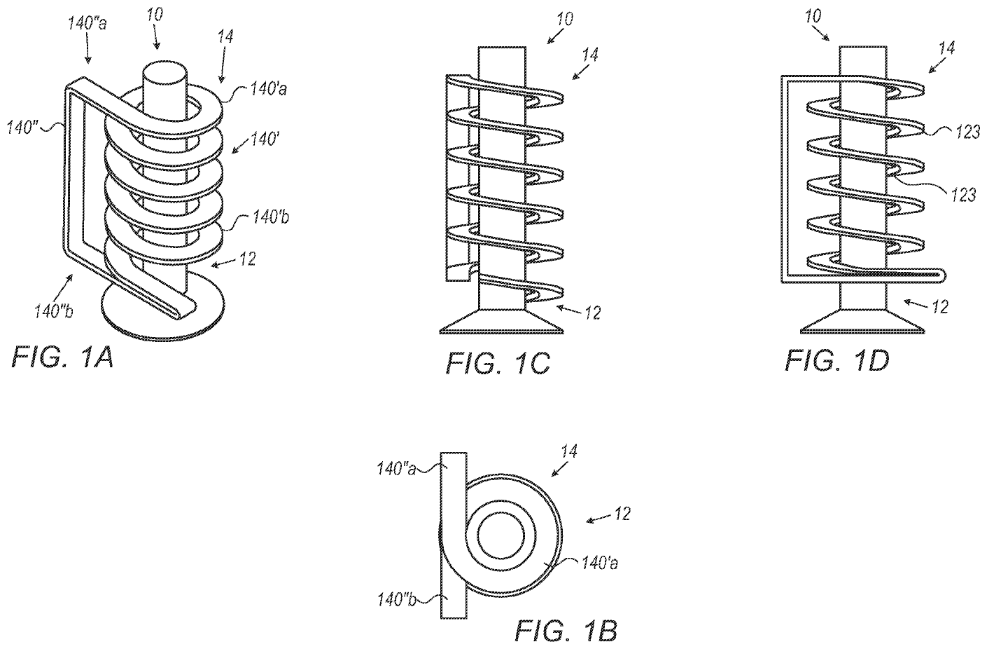

FIG. 1B illustrates a schematic, top plan view of a preferred implementation of apparatus according to the present finding;

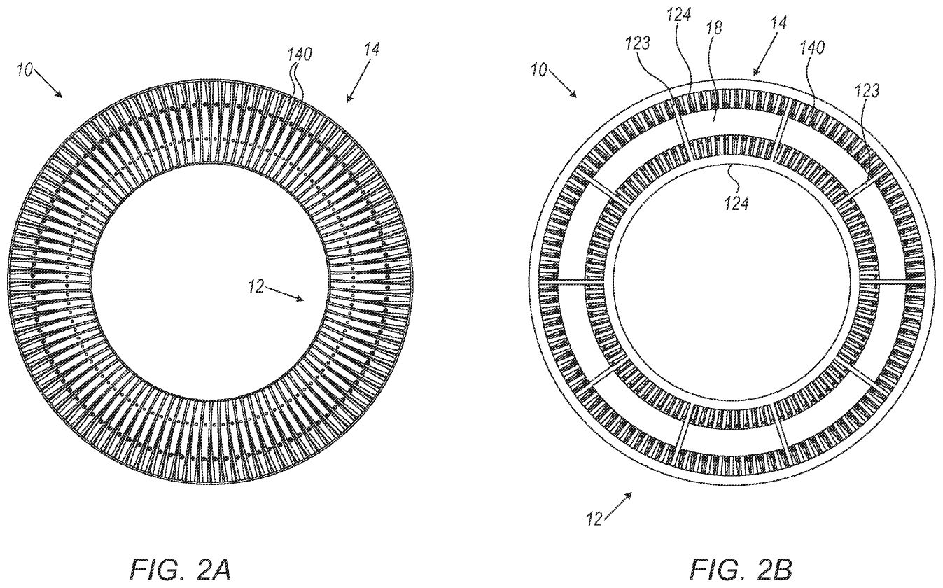

FIG. 1C illustrates a schematic, side elevational view of a preferred implementation of apparatus according to the present finding;

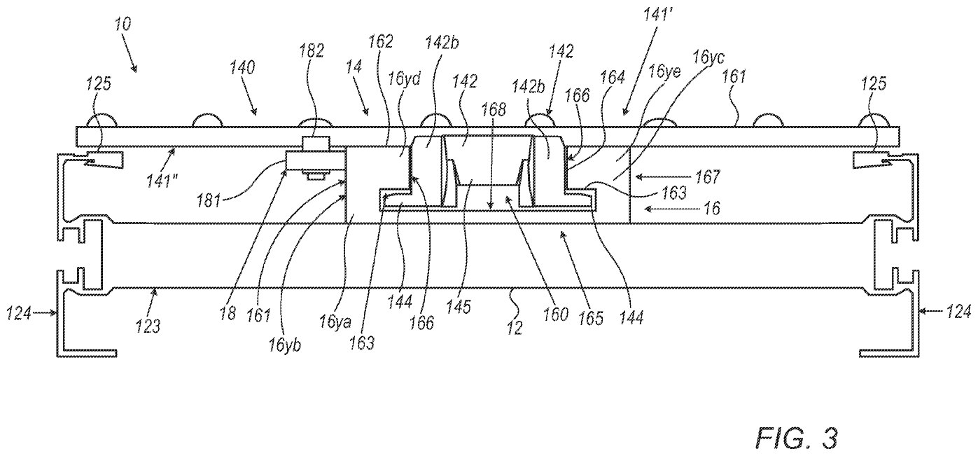

FIG. 1D illustrates a schematic, front elevational view of a preferred implementation of apparatus according to the present finding;

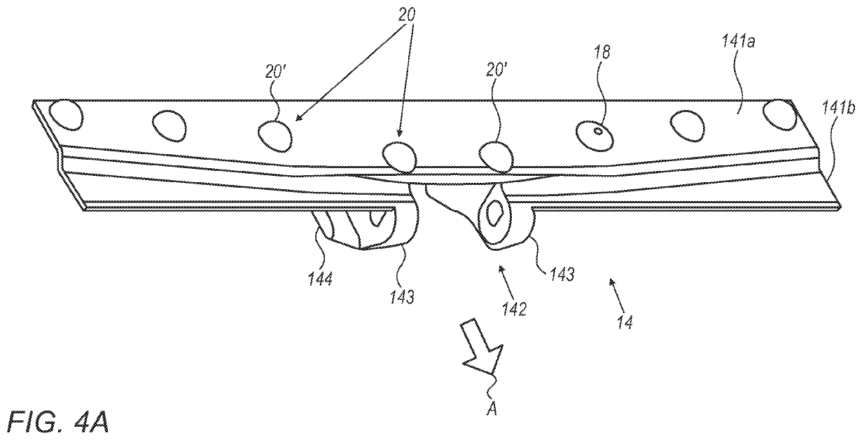

FIG. 2A illustrates a schematic, top plan view only of the conveyor belt of the preferred implementation of apparatus according to the present finding;

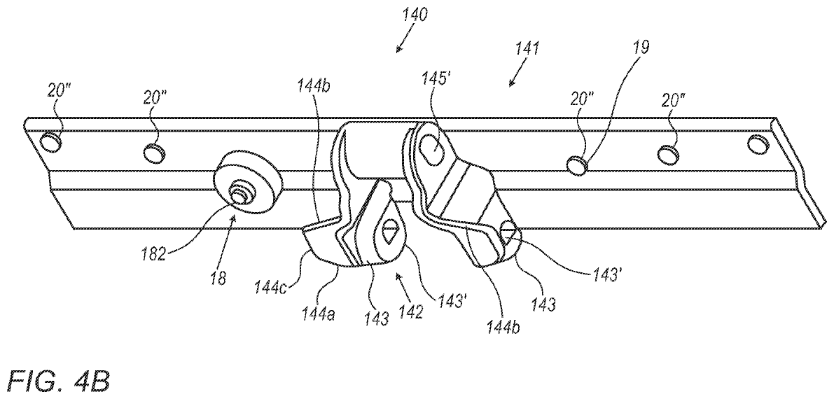

FIG. 2B illustrates a schematic, bottom plan view only of the conveyor belt of the preferred implementation of apparatus according to the present finding;

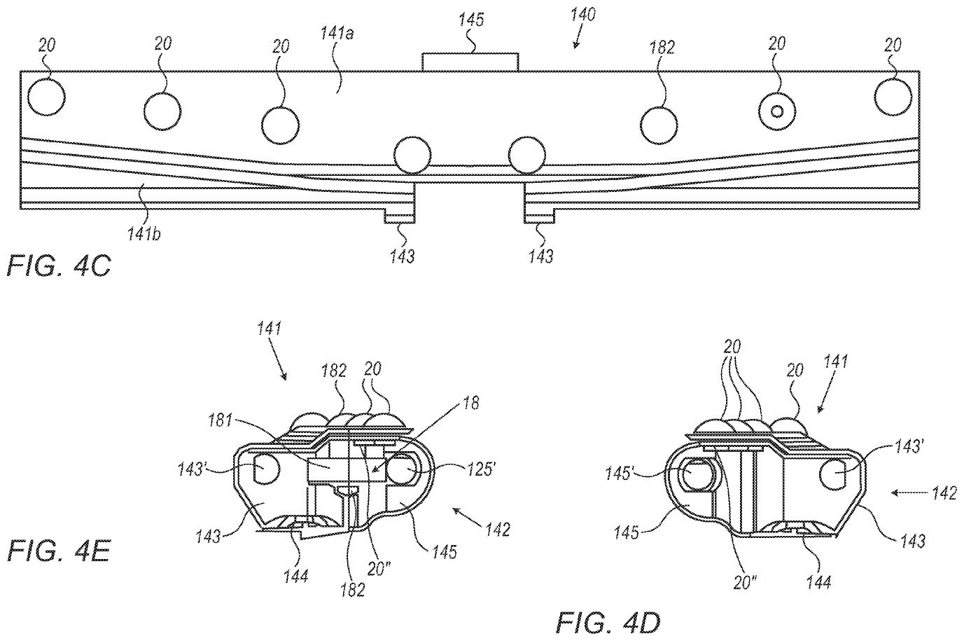

FIG. 3 illustrates a schematic, cross-sectional or radial view of the preferred implementation of apparatus according to the present finding;

FIGS. 4A to 4G illustrate different views only of the mesh of the conveyor belt of the preferred implementation of apparatus according to the present finding;

FIG. 5 illustrates a schematic, cross-sectional or radial view of a second preferred implementation of apparatus according to the present finding;

FIG. 6A illustrates a schematic, top plan view of a detail of the preferred implementation of the apparatus according to the present finding;

FIG. 6B illustrates a schematic, top plan view of a cross-sectional detail of the preferred implementation of apparatus according to the present finding, particularly illustrating a preferred implementation of the forwarding means of the conveyor belt used in the apparatus;

FIG. 6C illustrates a schematic, bottom plan view of a detail of the preferred implementation of apparatus according to the present finding, particularly illustrating the preferred implementation of the forwarding means of the conveyor belt used in the apparatus;

FIG. 6D illustrates a schematic, cross-sectional, bottom plan view of a detail of the preferred implementation of apparatus according to the present finding, particularly illustrating the preferred implementation of the forwarding means of the conveyor belt used in the apparatus;

FIG. 6E illustrates a perspective schematic view of a detail of the preferred implementation of apparatus according to the present finding, particularly illustrating the preferred implementation of the forwarding means of the conveyor belt used in the apparatus;

FIG. 6F illustrates a schematic, sectional view, taken according to the line B-B of FIG. 6A, of the preferred implementation of apparatus according to the present finding, particularly illustrating the preferred implementation of the forwarding means of the conveyor belt used in the apparatus.

### DETAILED DESCRIPTION OF PREFERRED IMPLEMENTATIONS OF THE FINDING

In the attached figures, a preferred implementation 10 of apparatus for transporting products on a respective path is illustrated, particularly comprising at least one curved route, i.e., a corresponding spiral route, particularly in which said spiral path is suitable to perform a corresponding ascending or descending movement length of the corresponding products. Particularly, said spiral route comprising one or more coils, or lengths having a respective helicoidal extension, preferably mutually consecutive.

The apparatus 10 comprises respective means 12 for supporting conveyor belt 14, particularly which conveyor belt 14 is composed of a plurality of meshes 140, preferably of rigid plastic material, which are mutually articulated, and in which preferentially the respective mesh 140 includes a respective small transversally extending plate 141 for supporting the product that, particularly, defining a resting surface 141′ for said product, and extending from the perpendicular side opposite the same surface 141′ for resting the product, a support portion 142 of said small plate 141 and articulating the mesh to the adjacent meshes of the conveyor belt 14.

As illustrated, the present implementation of conveying apparatus 10 comprises a conveyor belt having a plurality of coils 140′, vertically mutually aligned, and corresponding connecting length between the upper coil 140′a and the lower coil 140′b, which connecting length comprises at least one perpendicular length 140″ and corresponding substantially horizontal lengths 120″a and 120″b for a connection, or joining, to said upper 120′a and lower 120′b coils of the conveyor belt 14.

As is clear from the figures, said supporting and articulating portion 142 of the mesh is also slidable on a corresponding supporting and guiding elongated block 16 of said conveyor belt 14, i.e., of the corresponding meshes thereof.

Advantageously, it is provided for that said conveyor belt 14, particularly the respective mesh 140 thereof, comprises volving friction sliding means 18 that are adapted to engage said supporting and guiding elongated block 16 at a corresponding perpendicular face 161 thereof, which faces the outer side of the bend, i.e., which faces the side of said supporting and guiding elongated block 16 that is opposite the one facing the center of curvature of the corresponding curved, or spiral, route of the same conveyor belt 14.

In this manner, a reduction of the friction along the curved path, particularly a curved, spiral path, is obtained, thus reducing the towing power requirements, all with a configuration of the transporting apparatus that is particularly essential, i.e. that uses a relatively limited number of components.

As is clear from the figures, particularly, said supporting and guiding elongated block 16 of the conveyor belt, i.e. the corresponding meshes thereof, is arranged below said conveyor belt 14, i.e. the corresponding mesh 140 of the same conveyor belt 14.

Furthermore, as is clear from the figures, particularly, said supporting and guiding elongated block 16 of the conveyor belt, i.e. the corresponding meshes thereof, is arranged centrally to said conveyor belt 14, i.e. to the corresponding mesh 140 of the same conveyor belt 14.

As is clear from the figures, particularly, said supporting and guiding elongated block 16 of the conveyor belt, i.e. the corresponding meshes thereof, extends along a respective path, particularly comprising at least one curved route, i.e., according to a corresponding spiral route.

Furthermore, as is clear from the figures, particularly, said supporting and guiding elongated block 16 of the conveyor belt, i.e. the corresponding meshes thereof, extends in support by said means, or frame, for supporting the conveying apparatus 10.

As is clear from the corresponding figures, advantageously, the small transversally extending plate 141 for supporting the product defining the resting surface 141′ for said product extends laterally on both sides, preferably in a symmetrical manner, of said portion 142 for supporting and articulating the mesh 140.

In an advantageous manner, as is clear from said figures, said volving friction sliding means 18 are in the form of corresponding bearing, or caster, means that are distributed along said conveyor belt 14.

As is clear from the corresponding figures, with advantage, said volving friction sliding means 18 preferably comprise a corresponding bearing 18 that is directly carried by the respective mesh 140 of the conveyor belt 14.

With particular advantage, as is clear from the corresponding figures, said volving friction sliding means, or component, 18 are supported, particularly directly, on the small transversally extending plate 141 for supporting the product of the respective mesh 140 of the conveyor belt 14.

In an advantageous manner, as is clear from the corresponding figures, said volving friction sliding means, or component, 18 are rotatable with respect to an axis 180, perpendicular to said small plate 141 for supporting the product, i.e., with respect to an axis 180 that is parallel to the planar surface 161 of said supporting and guiding elongated block 16 which is engaged by the outer surface 181 of the same volving friction sliding means, or component 18.

As is clear from the figures, advantageously, said volving friction sliding means, or component, 18 have a circumferential and longitudinally planar, i.e. cylindrical, outer surface, 181 which is adapted to engage a corresponding planar side surface 161 of said supporting and guiding elongated block 16.

With advantage, as is clear from said figures, said small plate 141, transversally extending, for supporting the product has a lifted portion 141a and a lowered portion 141b, particularly adapted to be inserted, in use, at least partially below, or which is at least partially perpendicularly aligned to, said lifted portion of an adjacent mesh 140 of the same conveyor belt 14.

Said volving friction sliding means, or component, 18 are supported, in a freely rotatable manner, by said lifted portion 141a of said small plate 141 for supporting the product.

In an advantageous manner, as is clear from the figures, said volving friction sliding means, or component, 18 extend inferiorly to said small transversally extending plate 141 for supporting the product, in a side position with respect to the corresponding supporting and articulating portion 142 of the same mesh 140 of the conveyor belt 14, particularly on the part of said small plate 141 for supporting the product that faces the outer side of the bend.

As is clear from the figures, advantageously, said volving friction sliding means, or component, 18 are supported by a corresponding perpendicular pin 182, particularly secured to said small transversally extending plate 141 for supporting the product.

In an advantageous manner, as is clear from said figures, said perpendicular pin 182 extends from said lifted portion 141a of said small plate 141 for supporting the product and it is secured at a hole 19 obtained perpendicularly in said small plate 141.

As is clear from the figures, with advantage, on said small transversally extending plate 141 for supporting the product, means 20 for retaining the product resting on said resting surface 141′ of the same product are provided.

Advantageously, as is clear from the figures, said means 20 for retaining the product comprise one or more engaging means 20 associated to, or inserted in, one or more corresponding holes 19 provided in said small transversally extending plate 141 for supporting the product, particularly in said lifted portion 141a of the same small plate 141.

In an advantageous manner, as is clear from the figures, said members 20 for engaging the lower surface of the product are distributed along said small transversally extending plate 141 for supporting the product, particularly in said lifted portion 141a of said small plate 141 for supporting the product, according to a general V-shaped configuration.

Preferably, as illustrated, said means for retaining the product comprise a plurality of members 20 for engaging the lower surface of the product, which are secured to said mesh through corresponding perpendicular holes 19 provided in said small transversally extending plate 141 for supporting the product, particularly in said lifted portion 141a of said small plate 141 for supporting the product.

With advantage, said members 20 for engaging the lower surface of the product, are provided in a corresponding elastomeric material.

Particularly, as is clear from said figures, said members 20 for engaging the lower surface of the product, comprise a small head, particularly having a general shape of a spherical sector, 20′ and an insertion, particularly a snap-insertion, shaft 20″, into the corresponding hole 19.

As is clear from the figures, in an advantageous manner, said perpendicular pin 182, for the rotatable support of said volving friction sliding means, or component, 18, extends from said lifted portion 141a of said small transversally extending plate 141 for supporting the product and it is secured at a hole 19, which is usually adapted to house corresponding means, or a respective member, 20 for retaining the product resting on the resting surface of the same product.

In this manner, it is not necessary to obtain in said mesh 140 new and specific securing holes for said volving friction sliding means, or component, 18.

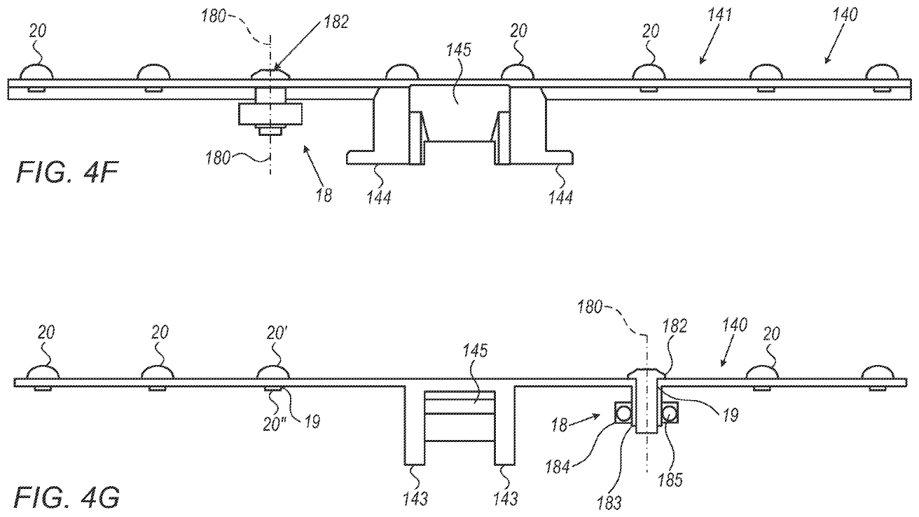

With particular advantage, as is clear in particular from FIG. 3, said supporting and guiding elongated block 16 of the meshes of the conveyor belt is in the form of an elongated body, particularly along the entire, or substantially the entire, extension of the conveyor belt, and has an inner cavity 160 for receiving said supporting and articulating portion 142 of said mesh 140 of the conveyor belt 14.

Advantageously, as is clear in particular from said FIG. 3, said supporting and guiding elongated block 16 has opposite retaining surfaces 163, 163 for corresponding transversal fins 144, 144 externally projecting, particularly from the perpendicular end, of said mesh supporting and articulating portion 142, which is opposite the one from which said small transversally extending plate 141 for supporting the product extends.

In an advantageous manner, as is clear in particular from said FIG. 3, said inner cavity 160 for receiving said mesh supporting and articulating portion 142 defines opposite undercut surfaces 163, 163 for retaining corresponding transversal fins 144, 144, externally projecting, particularly from the perpendicular end, of said mesh supporting and articulating portion 142, i.e. from the perpendicular end thereof which is opposite the one from which said small transversally extending plate 141 for supporting the product extends.

With advantage, as is clear in particular from said FIG. 3, said supporting and guiding elongated block 16 has an inlet mouth 164 in the undercut cavity 160, which is defined by corresponding and opposite perpendicular surfaces 166, 166 for an engagement against the opposite side faces, said mesh supporting and articulating portion 142, particularly thus defining corresponding centering means of said conveyor belt 14.

As is clear in particular from said FIG. 3, advantageously, said supporting and guiding elongated block 16 has opposite faces or flanking side surfaces, particularly perpendicular, 161, 167, one 161 facing the outer side of the bend, and the other one 167 facing the inner side of the same bend, respectively.

In an advantageous manner, as is clear in particular from the corresponding figures, said perpendicular pin 182 for supporting said volving friction sliding means, or component, 18 is defined by a corresponding securing rivet of said same volving friction sliding means, or component, 18 to said small transversally extending plate 141, for supporting the product.

In this manner, by virtue of the fact that the rivet creates a substantially integral connection, the loss of pieces by the conveyor is avoided to a maximum degree.

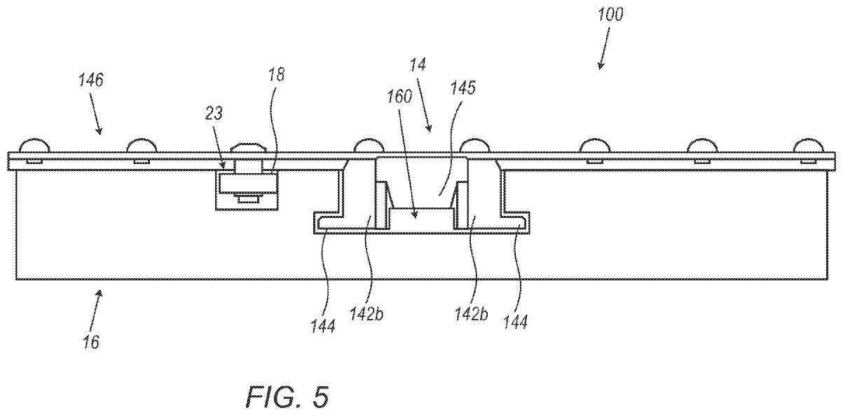

With particular advantage, as is clear in particular from said FIGS. 3, 4D, and 4G, said volving friction sliding means, or component, 18 are perpendicularly located slightly below said lowered portion 141b of said small transversally extending plate 141 for supporting the product.

With advantage, as is clear from the figures, said volving friction sliding means, or component, 18 engage the side surface 161 on the outer side of the bend of said supporting and guiding elongated block 16, in a corresponding position that is in the proximity of the respective resting end 162 for said small transversally extending plate 141 for supporting the product.

In an advantageous manner, as is clear in particular from said FIG. 3, said supporting and guiding elongated block 16 longitudinally extends according to the path, particularly the spiral path, for conveying said conveyor belt 14 and is supported through corresponding transversal members 123 supported by side struts 124 of the supporting structure, particularly said supporting and guiding elongated block 16 having a corresponding lower resting surface 165 on said transversal members 123.

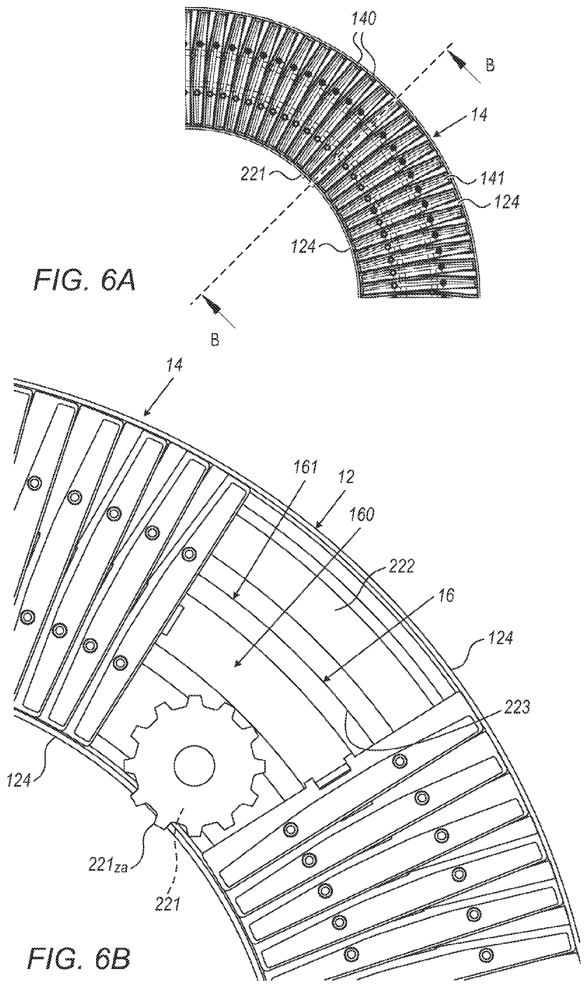

As is clear from FIG. 5, in which a further preferred implementation 100 of mesh of said conveyor belt 14 is illustrated, said supporting and guiding elongated block 16 extends transversally to support most of said small transversally extending plate 141 for supporting the product defining a respective perpendicularly recessed cavity 23 for the insertion of said volving friction sliding means, or component, 18, particularly said perpendicularly recessed cavity 23 for the insertion of said volving friction sliding means, or component, 18 being laterally located with respect to said inner cavity 160 for receiving said mesh supporting and articulating portion 142.

Advantageously, as is clear from the corresponding figures, said supporting and articulating portion 142 of the mesh comprises a small transversal block 145, from which longitudinally extend, particularly starting from the opposite side or transversal ends of this small block 145, corresponding side wings 142b, 142b supporting said fins 144, 144 for a perpendicular retaining of the respective mesh of said conveyor belt 14.

In an advantageous manner, as is clear from the corresponding figures, for articulating meshes adjacent, or longitudinally adjacent, meshes 140 of said conveyor belt 14, a corresponding pin is used, not particularly illustrated in the attached figures, which is adapted to insert in corresponding transversal holes respectively provided in said small transversal block 145 of the respective supporting and articulating portion 142 of the mesh and in said side wings 142b, 142b of the adjacent mesh, at which, or between which, said small transversal block 145 of the mesh is located.

With advantage, as referred to and as is also clear from said FIG. 3, said support means of the conveying apparatus comprise opposite first and second struts 124, 124, particularly extending according to a corresponding path, especially a curved or spiral path, which struts 124, 124 are preferably in a corresponding metal section bar and preferably support corresponding sliding means 125, 125 for the side ends of said small transversally extending plate 141 for supporting the product.

With particular advantage, as is clear from the corresponding figures, said support means 12 comprise a lower pedestal 121 and a central column member 122 from which a plurality of radial members extends, not illustrated in particular in the attached figures, which are adapted to support said supporting struts 124 of said conveyor belt 14.

In an advantageous and preferred manner, said volving friction sliding means, or component, 18 are provided on each mesh 140 of said conveyor belt 14. Anyhow, it shall be understood that, according to a different embodiment, said volving friction sliding means, or component, 18 could also be provided on meshes 140 of said conveyor belt 14, which are alternated with meshes of the same conveyor belt 14, on which said volving friction sliding means, or component, 18 are not provided.

Particularly, the respective mesh 140 of the conveyor belt 14 is of a moulded plastic material, preferably of a rigid or substantially rigid material.

Particularly, said supporting and guiding elongated block 16 is also of rigid plastic material.

In an advantageous manner, said volving friction sliding means, or component, 18 are preferably of a metal material.

Therefore, advantageously, as referred to herein above, said volving friction sliding means 18 are distributed along said conveyor belt 14, particularly, they are provided on corresponding meshes 140 of the conveyor belt 14, and preferably on each mesh 140 of the conveyor belt 14.

Advantageously, as cited herein above, said volving friction sliding means comprise, on the respective mesh 140 of the conveyor belt 14, a respective, and preferably single, component 18 defining a rotatable outer surface 181 for the engagement and sliding on said supporting and guiding elongated block 16.

In an advantageous manner, as is clear from FIG. 4G, said component defining a rotatable outer surface 181 for the engagement and sliding on said supporting and guiding elongated block 16 comprises, or is composed of, a bearing 18, particularly comprising a fixed annular member 183 that comprises an inner surface for the engagement with a corresponding support pin 182 and a rotatable annular member 184, coaxial and circumferentially outer to said fixed annular member 183, to which it is connected through corresponding rolling means, preferably in the form of corresponding rolling spheres, 185, which rotatable annular member 184 defines said outer surface 181 for the engagement and sliding on said supporting and guiding elongated block 16.

As referred to and as is clear from said corresponding figures, particularly advantageously, said mesh supporting and articulating portion 142 comprises a first and a second longitudinal wings 143, 143, perpendicularly extending with respect to said small transversally extending plate 141 for supporting the product, and transversally mutually spaced apart.

As is clear, said longitudinal wings 143, 143 are preferably generally diverging in the normal forwarding direction of said conveyor belt 14, marked by the arrow A in FIG. 4A, and from which, particularly from the corresponding perpendicular outermost edge, or free end, corresponding first and second fins 144, 144 transversally and externally extend, which are adapted to retain, in use, the respective mesh 140 according to a direction perpendicular to the same mesh, i.e. perpendicular to said conveyor belt 14.

As is clear, said first and second fins 144, 144 are perpendicularly spaced apart and preferably parallel from said small plate 141 for supporting the product and are respectively peripherally defined by corresponding transversal, particularly respectively front and rear, edges 144a, 144b, and by a corresponding longitudinal outermost edge 144c, which extends between said transversal edges 144a, 144b, at least one of which transversal edges 144a, 144b is preferentially oblique, i.e., as illustrated, they are both oblique, with respect to the direction longitudinal to said conveyor belt 14, and particularly being oriented mutually converging outwardly of said mesh 140 of the conveyor belt 14.

As reported, as is clear from said figures, said longitudinal wings 143, 143, perpendicularly extending with respect to said small plate 141 for supporting the product of said mesh supporting and articulating portion 142, are mutually connected, preferably at a respective longitudinal, preferably rear end according to the usual forwarding direction of said conveyor belt 14, through a small transversal block 145, particularly having a generally cylindrical outer profile, and having a transversal through hole 145′ aligned, in use, with corresponding transversal through holes 143′, 143′, of the respective adjacent longitudinal mesh 140, and which are obtained in said longitudinal wings 143, 143, perpendicularly extending with respect to said small transversally extending plate 141 for supporting the product, particularly at the respective end that is opposite the one where said small transversal block 145 is located, said holes being adapted to receive the insertion of a corresponding transversal pin articulating the same mesh 140 of the conveyor belt 14 with the respective adjacent longitudinal mesh 140 of the same conveyor belt 14.

In an advantageous manner, as is clear from said FIG. 3, said figures, in practice, said supporting and guiding elongated block 16 comprises a bottom wall 16ya, particularly defining a lower resting surface 165 on the transversal member 144 of said support means 12 of said apparatus 10 and, on the opposite perpendicular side, a bottom surface 168 of said inner cavity 160 for receiving said mesh supporting and articulating portion 142 of said conveyor belt 14.

Furthermore, with advantage, as is clear from said FIG. 3, said supporting and guiding elongated block 16 comprises a, particularly a first, wall 16yb, particularly extending perpendicularly, or in elevation, from said bottom wall 16ya and defining, with the perpendicular face thereof radially outer with respect to the bend, said perpendicular face, or surface, 161 for the engagement by the sliding means 18, as well understood from the present description.

Furthermore, particularly advantageously, as is clear from said FIG. 3, said supporting and guiding elongated block 16 comprises a, particularly a second, side wall 16yc, especially transversally spaced apart from said first side wall 16yb, particularly extending perpendicularly, or in elevation, from said bottom wall 16ya, and defining, with its outer perpendicular face, said perpendicular face, or surface, 167 of said supporting and guiding elongated block 16 of the conveyor belt 14 which faces the inner side of the same bend.

As is clear from said FIG. 3, in an advantageous manner, said elongated supporting and guiding block comprises a, particularly a first, transversal segment 16yd, preferably horizontal and/or parallel to said bottom wall 16ya, particularly which extends from the corresponding, or first, side wall 16yb towards the inner part of said elongated supporting and guiding block 16 and which defines said, or part of said, resting surface 162 for said small plate for supporting the product 141, and, on the perpendicular opposite side, a corresponding retaining surface 163 for a corresponding transversal fin 144 externally projecting from said mesh supporting and articulating portion 142 of said conveyor belt 14, as well as a corresponding perpendicular end surface 166, particularly for the passage of said mesh supporting and articulating portion 142 into said elongated supporting and guiding elongated block 16 of the conveyor belt 14 and/or for the side centering of said conveyor belt 14.

Advantageously, as is clear from said figures, said elongated supporting and guiding block comprises one, particularly a second, transversal segment 16ye, preferably horizontal and/or parallel to said bottom wall 16ya, particularly which extends from the corresponding, particularly second, side wall 16yc of said elongated supporting and guiding block 16, especially transversally opposite said first transversal segment 16yd, and which defines said, or part of said, resting surface 162 for said small plate for supporting the product 141, and, on the perpendicular opposite side, a corresponding retaining surface 163 for a corresponding transversal fin 144 externally projecting from said mesh supporting and articulating portion 142 of said conveyor belt 14, as well as a corresponding perpendicular end surface 166, for the side centering of said conveyor belt 14 and particularly defining, together with the opposite perpendicular end surface of said first transversal segment 16yd, said inlet mouth 164 into the inner cavity of said supporting and guiding elongated block 16 of the conveyor belt 14.

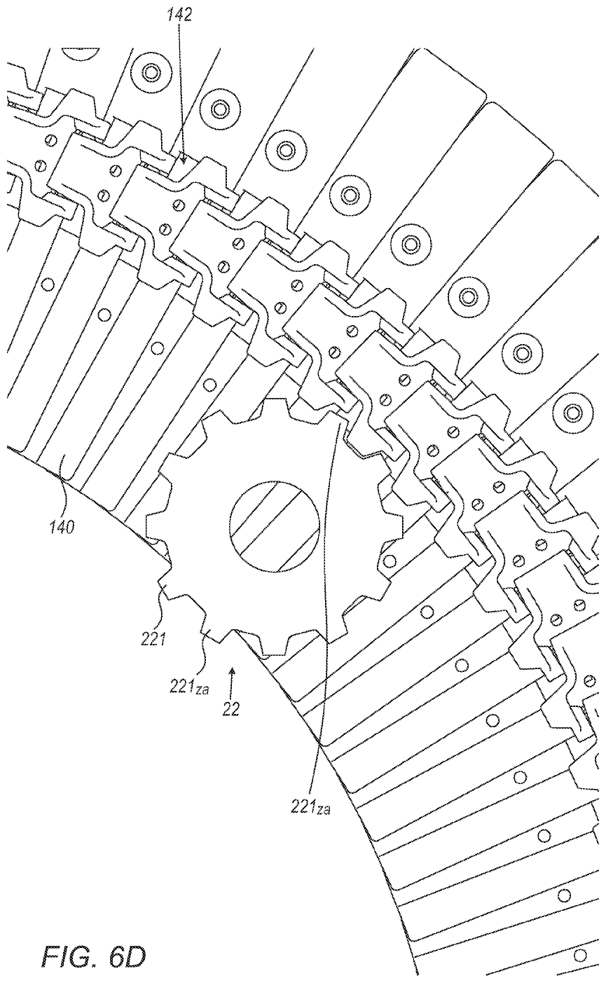

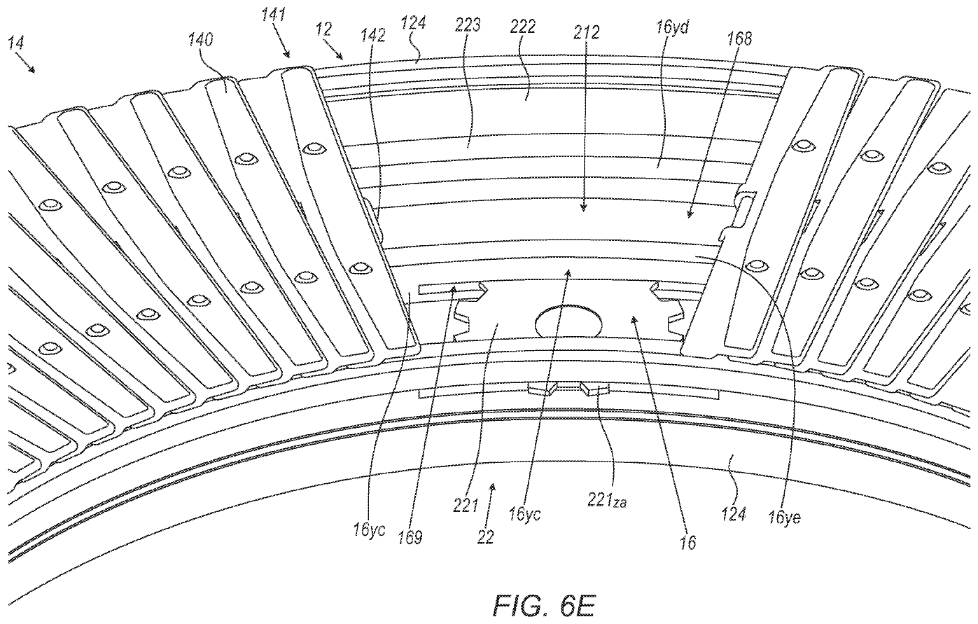

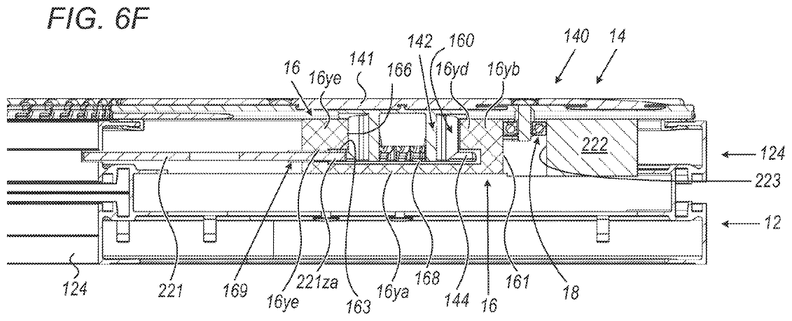

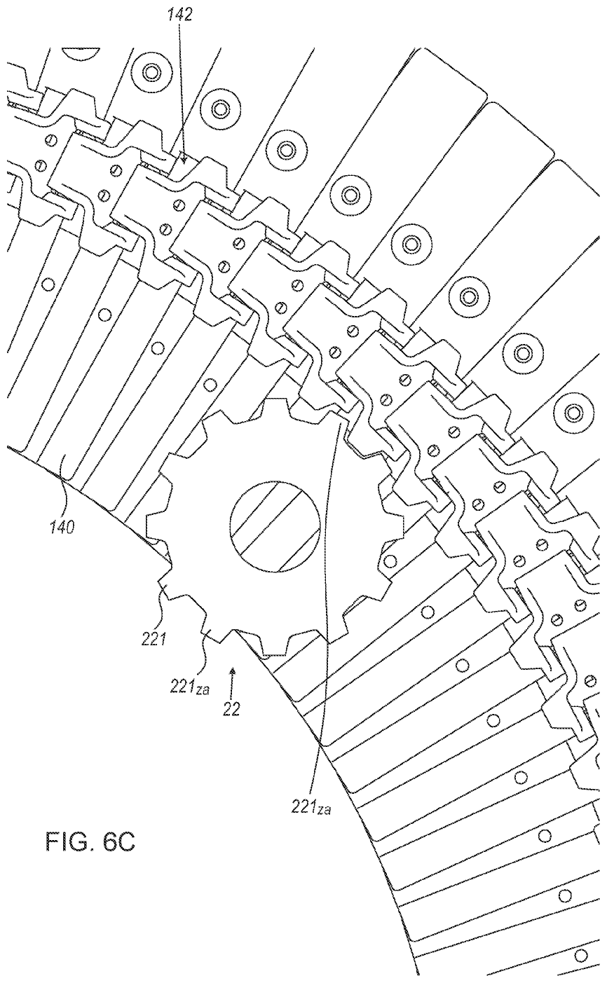

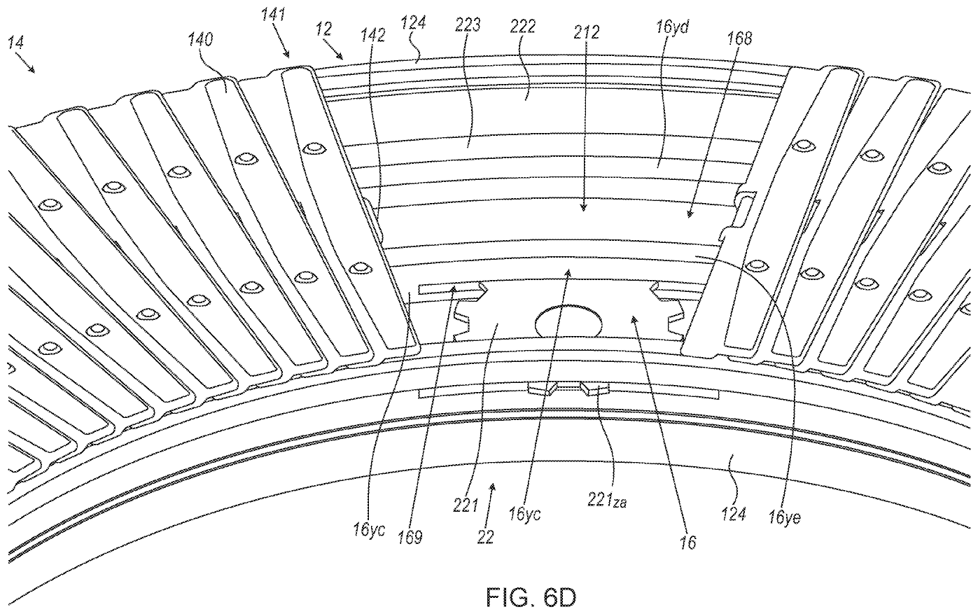

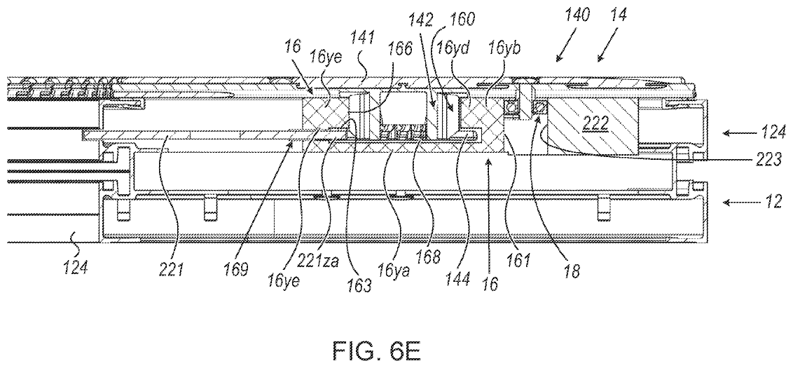

With particular advantage, as is clear particularly from FIGS. 6A to 6F, in present apparatus, advantageous forwarding means 22 of the conveyor belt 14 are also provided.

In an advantageous manner, as is clear from said FIGS. 6A to 6F, particularly, said forwarding means 22 of the conveyor belt 14 comprise towing means 221 of said conveyor belt 14.

Particularly advantageously, as is clear from said FIGS. 6A to 6F, preferably, said towing means 221 of the conveyor belt 14 are adapted to engage, or mesh with, said conveyor belt 14, particularly with the meshes of said conveyor belt 14, i.e. with a corresponding transversal surface 144b of the corresponding mesh 140 of the conveyor belt 14.

As is clear from said FIGS. 6A to 6F, advantageously, said towing means 221 of the conveyor belt 14 are arranged parallel to said conveyor belt 14, i.e. the respective small plate 141, transversally extending, for supporting the product.

In an advantageous manner, as is clear from said FIGS. 6A to 6F, said towing means 221 of the conveyor belt 14 are arranged in a lower position with respect to the respective small plate 141, transversally extending, for supporting the product of said mesh 140 of the conveyor belt 14 and next to said portion 142 for supporting and articulating the same mesh 140, which is preferably engaged or meshed, to tow said conveyor belt 14, by the same towing means 221 of said conveyor belt 14.

With advantage, as is clear from said FIGS. 6A to 6F, said towing means 221 of the conveyor belt, during a towing action, engage a corresponding transversal, particularly rear and preferably oblique, edge 144b, of the corresponding side fin 144 of said mesh supporting and articulating portion 142 of the same conveyor belt 14.

Particularly advantageously, as is clear from said FIGS. 6A to 6F, said towing means 221 of the conveyor belt 14 acting to engage the corresponding transversal surface 144b of said conveyor belt 14, i.e., of the corresponding transversal edge 144b of said fin 144 of said mesh supporting and articulating portion 142 of the same conveyor belt 14, extend into said supporting and guiding elongated block 16 of the conveyor belt through a corresponding split 169 provided therein 14.

In an advantageous manner, as is clear in particular from said FIG. 6F, said towing means 221 of the conveyor belt 14, acting to engage the corresponding transversal surface 144b of the same conveyor belt 14, i.e., of said transversal edge 144b of the same fin 144 of said mesh supporting and articulating portion 142 of the same conveyor belt 14, extend into said supporting and guiding elongated block 16 of the conveyor belt 14, arriving in a substantially perpendicular correspondence, or in almost perpendicular correspondence, of said perpendicular end surface 166 defining said inlet mouth 164 into the inner cavity of said supporting and guiding elongated block 16 of the conveyor belt 14 or for the side centering of said conveyor belt 14, particularly provided at the end of the corresponding, or second, transversal segment 16ye of said supporting and guiding elongated block 16 of the conveyor belt 14.

As is clear from said FIGS. 6A to 6F, with particular advantage, the respective corresponding wall in elevation, i.e. said second side wall, 16yc of said supporting and guiding elongated block 16 of the conveyor belt 14, has a corresponding split 169 for the extension of said towing means 221 of said conveyor belt 14, i.e. of respective meshing teeth 221za, towards and in engagement with the corresponding transversal surface 144b of said conveyor belt 14, i.e. the corresponding transversal edge of the respective fin 144 of said mesh supporting and articulating portion 142 of the same conveyor belt 14.

Advantageously, as is clear from said FIGS. 6A to 6F, and anyhow particularly from said FIG. 6F, said split 169 for the extension of said towing means 221 of said conveyor belt 14, i.e. of respective meshing teeth 221za, towards and in engagement with the corresponding transversal surface 144b of said conveyor belt 14, i.e. the corresponding transversal edge of the respective fin 144 of said mesh supporting and articulating portion 142 of the same conveyor belt 14, is provided, i.e. opens, in the corresponding wall in elevation, i.e. in said second wall in elevation, 16yc of said supporting and guiding elongated block 16 of the conveyor belt 14, below the corresponding, or second, transversal segment 16ye, i.e., below, or slightly below, said retaining surface 163 for the corresponding transversal fin 144 of the mesh of said conveyor belt 14, and particularly being provided between this retaining surface 163 and the corresponding bottom surface 168 of said inner cavity 160 for receiving said mesh supporting and articulating portion 142 of said conveyor belt 14.

In an advantageous manner, as is clear from said FIGS. 6A to 6F, said towing means of said conveyor belt 14 are in the form of corresponding wheel means, particularly comprising a respective wheel 221.

Particularly, said towing means of said conveyor belt 14 comprise a plurality of wheels, 221, which are distributed along the spiral path of said conveyor belt 14, particularly at respective vertically aligned positions and/or especially acting on corresponding coils of said conveyor belt 14, and preferably at each coil 120′ of the same conveyor belt 14.

Particularly advantageously, as is clear from said FIGS. 6A to 6F, the respective towing wheel 221 of the conveyor belt 14 comprises a plurality of radial teeth 221za for the engagement or meshing with the corresponding transversal surface 144b of said conveyor belt 14, and particularly having a respective engaging profile 221zb corresponding to the profile, particularly oblique, of the corresponding transversal surface 144b of said conveyor belt 14, i.e. the transversal edge of said fin 144 of said mesh supporting and articulating portion 142 of the same conveyor belt 14.

Advantageously, as is clear from said FIGS. 6A to 6F, said split 169, for the passage of said towing means 221 of said conveyor belt 14 towards, and in engagement with, the corresponding transversal surface 144b of said conveyor belt 14, i.e., towards, and in engagement with, the corresponding transversal edge of said fin 144 of said mesh supporting and articulating portion 142 of the same conveyor belt 14, has a length, according to the extension direction of said conveyor belt 14, which is larger, particularly slightly larger, than the diameter of the same towing wheel 221.

As is clear from said FIGS. 6A to 6F, in an advantageous manner, the towing wheel 221 lies entirely below the conveyor belt, especially said small transversally extending plate 141 for supporting the product, particularly lying at the corresponding part of the same conveyor belt 14 that is comprised between the midline and the inner side thereof.

With particular advantage, as is clear from said FIGS. 6A to 6F, said forwarding means 22 of said conveyor belt 14 comprise means 222 acting on said conveyor belt 14 in opposition to said towing means 221 of the conveyor belt 14.

In this manner, the engagement, or meshing, of said towing means with said conveyor belt 14 is promoted.

Particularly advantageously, as is clear from said FIGS. 6A to 6F, said means 222 acting on said conveyor belt 14 in opposition to said towing means 221 of the conveyor belt 14 extend arched and preferably concentric to the curved path of the same conveyor belt 14.

In an advantageous manner, as is clear from said FIGS. 6A to 6F, said means 222 acting on said conveyor belt 14 in opposition to said towing means 221 of the conveyor belt extend by an arc of a circle longer than the engagement extent of said towing means 221 con said conveyor belt 14, or than the diameter of said means, or the respective wheel, 221 for towing the same conveyor belt 14.

With advantage, as is clear from said FIGS. 6A to 6F, said means 222 acting on said conveyor belt 14 in opposition to said towing means 221 of the conveyor belt 14 lie, particularly, entirely below the conveyor belt, especially of said small transversally extending plate 141 for supporting the product, especially lying at the corresponding part of the same conveyor belt 14 that is comprised between the midline and the outer side thereof.

As is clear from said FIGS. 6A to 6F, advantageously, said means 222 acting on said conveyor belt 14 in opposition to said towing means 221 of the conveyor belt 14 define sliding engaging means with said conveyor belt 14.

In an advantageous manner, as is clear from said FIGS. 6A to 6F, said conveyor belt 14 slides in a volving friction on said means 222 acting on the same conveyor belt 14 in opposition to said towing means 221 of the conveyor belt 14.

In this manner, an advancement, or sliding, of the conveyor belt that is particularly effective can be obtained.

Particularly advantageously, as is clear from said FIGS. 6A to 6F, said opposition means of said sliding engagement means comprise a corresponding outer bar 222za, particularly arched and concentric to the same conveyor belt 14 defining a sliding guide for said conveyor belt 14.

With particular advantage, as is clear from said FIGS. 6A to 6F, said conveyor belt 14 supports corresponding rotatable, or volving friction means, 18 which are adapted to slidingly engage said means, or guide, 222 acting on said conveyor belt 14 in opposition to said towing means 221 of the conveyor belt 14.

In an advantageous manner, as is clear from said FIGS. 6A to 6F, said rotatable, or volving friction means, 18 are adapted to rotatably engage an inner face, or facing the center of the corresponding curved length, 223, particularly perpendicularly extending of said means, or guide, 222 acting on said conveyor belt 14 in opposition to said towing means 221.

As is clear from the figures, advantageously, said rotatable, or volving friction means, comprise a corresponding rotatable component 18 having an outer surface 181 for the engagement and sliding on said means, or guide, 222 acting on said conveyor belt 14 in opposition to said towing means 221 of the conveyor belt 14, which is supported by a corresponding mesh 140 of the conveyor belt 14, preferably, as illustrated, a respective rotatable component 18 being supported by each mesh of the same conveyor belt 14.

Particularly advantageously, as is clear from said figures, said rotatable means, or component, 18 for sliding with a volving friction on said means, or guide, 222, acting on said conveyor belt 14 in opposition to said towing means 221 of the conveyor belt 14, are defined by the same rotatable volving friction sliding means, or component, 18 which are adapted to slide on said supporting and guiding elongated, particularly central block, 16 of said conveyor belt 14.

In this manner, apparatus is obtained, which has a particularly essential configuration and with a particularly reduced number of components.

In an advantageous manner, as is clear from said FIGS. 6A to 6F, said volving friction sliding means 18, in use, are arranged between said supporting and guiding elongated block 16 of the conveyor belt 14 and said sliding engaging means 222 acting on said conveyor belt 14 in opposition to said towing means 221 of said conveyor belt 14, i.e. between the respective engaging surfaces 161 and 223 thereof.

In practice, said volving friction sliding means 18 engage in an alternated manner said supporting and guiding elongated block 16 of the conveyor belt 14 and said sliding engaging means 222 acting on said conveyor belt 14 in opposition to said towing means 221 of said conveyor belt 14, i.e. the respective and opposite engaging surfaces 161 and 223 thereof.

With particular advantage, as is clear from said FIGS. 6A to 6F, the outer surface 161, of said supporting and guiding elongated block 16 of the conveyor belt 14, which is engaged by said volving friction sliding means 18, is arranged at a distance from said inner surface 223, of said means, or guide, 222 acting on said conveyor belt 14 in opposition to said towing means 221 of the conveyor belt 14, which is slightly larger than the width, or diameter, of the same volving friction sliding means 18.

In this manner, by taking advantage of the yoke that is present between the supporting and articulating portion 142 for supporting and articulating the mesh of the same conveyor belt 14 and opposite perpendicular surfaces 166, 166 for an engagement against the opposite side faces, said mesh supporting and articulating portion 142, the radial thrust of said towing means 221 of the conveyor belt 14 is adapted to force said volving friction sliding means 18 against the surface 223 of the outer guide 222 and to avoid the friction with the opposite surface 161 of said supporting and guiding elongated block 16 of the conveyor belt 14.

While it is not particularly illustrated in the attached figures, in an advantageous manner, actuating means for said towing means 221 of the conveyor belt 14 can be provided, which particularly comprise a respective motor and a corresponding, particularly vertically extending, drive shaft, which receives the motion from said motor, and which is connected to corresponding towing means, or wheel, 221 of the conveyor belt 14, through a corresponding toothed ratchet, which, in turn, moves a corresponding chain, particularly lying in a horizontal, or substantially horizontal plane, and which transmits the movement to said towing means 221 of the conveyor belt 14.

Particularly advantageously, it can be expected that said means for actuating said towing means 221 of the conveyor belt 14, i.e., the respective drive shaft 242, extend internally to said spiral-shaped conveyor belt 14, i.e., inside the respective inner edge of the same conveyor belt 14.

Particularly, as is clear from said FIGS. 6A to 6F, said means, or guide, 222 acting on said conveyor belt 14 in opposition to said towing means 221 of the conveyor belt 14 are supported by corresponding and adjacent transversal members 123, 123 of said support means 12 of the apparatus 10.

In practice, as is clear, the above-illustrated technical characteristics allow, individually or in a respective combination, to achieve one or more of the following advantageous results:
an advancement, or sliding, of the conveyor belt that is particularly effective can be obtained;
a reduction of the friction during the curved path, particularly during the spiral path of the conveyor belt, is obtained, thus reducing the towing power requirements, particularly even during the towing action of the same conveyor belt;
an apparatus is obtained, which has a particularly essential configuration;
an apparatus is obtained, which has a relatively limited number of components;
it is not necessary to obtain meshes of the conveyor belt having further securing holes for said volving friction sliding means, or component, which may weaken the structure of the same conveyor belt mesh.

The present finding is susceptible of evident industrial application. The person skilled in the art can also devise a number of modifications and/or variations to be made to the same finding, while still remaining within the scope of the inventive concept, as widely explained. Furthermore, the person skilled in the art will be able to devise further preferred implementations of the finding, which comprise one or more of the characteristics illustrated herein above of the preferred implementation. Furthermore, it must also be understood that all the details of the finding can be replaced by technically equivalent elements.

1-58. (canceled)

59. An apparatus for transporting products on a respective path, particularly comprising at least one curved length or a corresponding spiral route, the apparatus comprising respective support means of a conveyor belt, particularly comprising a plurality of mutually articulated meshes, wherein preferably the respective mesh has a respective transversally extending small plate for supporting the product, defining a resting surface for said product, and, extending from the perpendicular side opposite the same resting surface of the product, a portion for supporting said small plate for supporting the product and articulating the mesh to the adjacent meshes of the conveyor belt, which supporting and articulating portion of the mesh is slidable on a corresponding elongated block for supporting and guiding said means for supporting the apparatus; wherein said conveyor belt (14), particularly the respective mesh (140) thereof, comprises volving friction sliding means (18) that are adapted to engage said supporting and guiding elongated block (16) at a corresponding perpendicular surface face (161) thereof which faces the outer side of the bend.

60. The apparatus according to claim 59, wherein said elongated block for supporting and guiding the conveyor belt, i.e. the corresponding meshes thereof, is arranged below and/or centrally to said conveyor belt, i.e. to the corresponding mesh of the conveyor belt.

61. The apparatus according to claim 59, wherein said volving friction sliding means are distributed along said conveyor belt, particularly, they are provided on corresponding meshes of the conveyor belt, preferably on each mesh of the conveyor belt.

62. The apparatus according to claim 59, wherein said volving friction sliding means comprise, on the respective mesh of the conveyor belt, a respective, and preferably single, component defining a rotatable outer surface for the engagement and sliding on said elongated supporting and guiding block.

63. The apparatus according to claim 59, wherein said volving friction sliding means, or component, are supported on the small plate, transversally extending, for supporting the product of the respective mesh of the conveyor belt.

64. The apparatus according to claim 59, wherein said volving friction sliding means, or component, are rotatable with respect to an axis perpendicular to said small plate for supporting the product, i.e., with respect to an axis that is parallel to the planar surface of said elongated supporting and guiding block which is engaged by the outer surface of the same volving friction sliding means, or component.

65. The apparatus according to claim 59, wherein said volving friction sliding means, or component have a circumferential and longitudinally planar, i.e. cylindrical, outer surface, which is adapted to engage a corresponding planar side surface of said elongated supporting and guiding block.

66. The apparatus according to claim 59, wherein said small transversally extending plate for supporting the product has a lifted portion and a lowered portion, particularly adapted to be inserted, in use, at least partially below, or which is at least partially perpendicularly aligned to, the lifted portion of an adjacent mesh of the same conveyor belt; said volving friction sliding means, or component being supported, in a freely rotatable manner, by said lifted portion of said small plate, transversally extending, for supporting the product.

67. The apparatus according to claim 59, wherein said volving friction sliding means or component extend inferiorly to said small plate, transversally extending, for supporting the product, in a side position with respect to the corresponding supporting and articulating portion of the same mesh of the conveyor belt, particularly on the part of said small plate for supporting the product that faces the outer side of the bend.

68. The apparatus according to claim 59, wherein said volving friction sliding means, or component are supported by a corresponding perpendicular pin, particularly secured to said small plate, transversally extending, for supporting the product; said perpendicular pin extending from said lifted portion of said small plate, for supporting the product and it is secured at a hole obtained perpendicularly in said small plate.

69. The apparatus according to claim 59, wherein said mesh supporting and articulating portion comprises a first and a second longitudinal wings, perpendicularly extending with respect to said small transversally extending plate for supporting the product, and transversally mutually spaced apart, and preferably generally diverging in the normal forwarding direction of said conveyor belt, and from which, particularly from the corresponding perpendicular outermost edge, or free end, corresponding first and second fins transversally and externally extend, which are adapted to retain, in use, the respective mesh according to a direction perpendicular thereto, i.e. perpendicular to said conveyor belt; said first and second fins being perpendicularly spaced apart and preferably parallel from said small plate for supporting the product and being respectively peripherally defined by corresponding transversal, particularly respectively front and rear, edges, and by a corresponding longitudinal outermost edge which extends between said transversal edges, at least one of which transversal edges is preferentially oblique, i.e., they are both oblique, with respect to a direction longitudinal to said conveyor belt, and particularly being oriented mutually converging outwardly of said mesh of the conveyor belt.

70. The apparatus according to claim 59, wherein said longitudinal wings, perpendicularly extending with respect to said small plate for supporting the product of said mesh supporting and articulating portion, are mutually connected, preferably at a respective longitudinal, preferably rear end according to the usual forwarding direction of said conveyor belt, through a small transversal block, particularly having a generally cylindrical outer profile, and having a transversal through hole aligned, in use, with corresponding transversal through holes, of the respective adjacent longitudinal mesh, and which are obtained in said longitudinal wings, perpendicularly extending with respect to said small plate transversally extending for supporting the product, particularly at the respective end that is opposite the one in which said small transversal block is located, said holes being adapted to receive the insertion of a corresponding transversal pin articulating the same mesh of the conveyor belt with the respective adjacent longitudinal mesh of the same conveyor belt.

71. The apparatus according to claim 59, wherein said elongated supporting and guiding block of the meshes of the conveyor belt is in the form of an elongated body, particularly along the entire, or substantially the entire, extension of the conveyor belt, and has an inner cavity for receiving said supporting and articulating portion of said mesh of the conveyor belt.

72. The apparatus according to claim 59, wherein said elongated supporting and guiding block of the meshes of the conveyor belt has an upper surface for slidingly supporting the lower face of said small transversally extending plate for supporting the product.

73. The apparatus according to claim 59, wherein said elongated supporting and guiding block has opposite retaining surfaces for corresponding transversal fins externally projecting, particularly from the perpendicular end, of said mesh supporting and articulating portion, which is opposite the one from which said small transversally extending plate for supporting the product extends.

74. The apparatus according to claim 71, wherein said inner cavity for receiving said mesh supporting and articulating portion defines opposite undercut surfaces for retaining corresponding transversal fins, externally projecting, particularly from the perpendicular end, of said mesh supporting and articulating portion, i.e. from the perpendicular end thereof which is opposite the one from which said small transversally extending plate for supporting the product extends.

75. The apparatus according to claim 59, wherein said elongated supporting and guiding block has an inlet mouth in the undercut cavity, which is defined by corresponding and opposite perpendicular surfaces for an engagement against the opposite side faces, said mesh supporting and articulating portion particularly thus defining corresponding centering means of said conveyor belt.

76. The apparatus according to claim 59, wherein said elongated supporting and guiding block comprises a, particularly a first, wall, particularly extending perpendicularly, or in elevation, from said bottom wall and defining, with the perpendicular face thereof radially outer with respect to the bend, said perpendicular face, or surface, for the engagement by the sliding means.

77. The apparatus according to claim 76, wherein said elongated supporting and guiding block comprises a, particularly a second, side wall, especially transversally spaced apart from said first side wall, particularly extending perpendicularly, or in elevation, from said bottom wall, and defining, with its outer perpendicular face, said perpendicular face, or surface, of said elongated supporting and guiding block of the conveyor belt which faces the inner side of the same bend.

78. The apparatus according to claim 59, wherein said elongated supporting and guiding block comprises a, particularly a first, transversal segment, preferably horizontal and/or parallel to said bottom wall, particularly which extends from the corresponding, or first, side wall towards the inner part of said elongated supporting and guiding block and which defines said, or part of said, resting surface for said small plate for supporting the product, and, on the perpendicular opposite side, a corresponding retaining surface for a corresponding transversal fin externally projecting from said supporting and articulating portion of the mesh of said conveyor belt, as well as a corresponding perpendicular end surface, particularly for the passage of said mesh supporting and articulating portion into said elongated supporting and guiding block of the conveyor belt and/or for the side centering of said conveyor belt; and/or in that said elongated supporting and guiding block comprises one, particularly a second, transversal segment, preferably horizontal and/or parallel to said bottom wall, particularly which extends from the corresponding, particularly second, side wall of said elongated supporting and guiding block, especially transversally opposite said first transversal segment, and which defines the, or part of, said resting surface for said small plate for supporting the product, and, on the perpendicular opposite side, a corresponding retaining surface for a corresponding transversal fin externally projecting from said mesh supporting and articulating portion of said conveyor belt, as well as a corresponding perpendicular end surface, for the side centering of said conveyor belt and particularly defining, together with the opposite perpendicular end surface of said first transversal segment, said inlet mouth into the inner cavity of said elongated supporting and guiding block of the conveyor belt.
